(19) United States
(12) Patent Application Publication
(10) Pub. No.: US 2013/0319196 A1
(43) Pub. Date: Dec. 5, 2013

(54) METHOD FOR SLICING A FOOD SLAB WITH USE OF AN OSCILLATION SENSOR

(71) Applicant: GEA CFS Buhl GmbH, (US)

(72) Inventor: Jorg Schmeiser, Wiggensbach (DE)

(73) Assignee: GEA CFS BUHL GMBH, Kempten (DE)

(21) Appl. No.: 13/681,658

(22) Filed: Nov. 20, 2012

(30) Foreign Application Priority Data
Nov. 30, 2011 (DE) 10 2011 119 719.6

(51) Int. Cl. B26D 5/02

(52) U.S. Cl. CPC B26D 5/02
USPC 83/34; 83/13

(57) ABSTRACT

The present invention relates to a method for slicing a food slab info food slices by means of a slicing device, which has a cutting blade with which the food slices are separated from the food slab.

### FIELD

The present invention relates to a method for slicing a food slab into food slices by means of a slicing device, which has a cutting blade with which the food slices are separated from the food slab.

### BACKGROUND

The generic method is known by “high-performance slicing devises”, as are described for example in DE 10001338, EP 0107056, EP 0687263 and GB 2386317. With these “slicers”, bar-shaped or otherwise shaped food slabs, for example sausage, cheese, ham, smoked ham or the like, are cut into slices at a very high cutting output, for example up to 1,000 cuts per minute or more. During this process for example, the food slab is transported by means of a controlled drive through a fixed cutting plane in which the cut is made by a quick-moving, generally rotating, cutting blade. The thickness of the cut is determined from the distance over which the food slab is advanced between two cuts. With a constant speed of rotation of the cutting blade, the thickness of the slice is therefore controlled via the feed rate of the food slab. The cut slices are combined to form portions, generally with a constant number of slices and/or in a weight-accurate manner, and are packed. A problem, however, when slicing food slabs is that the cross section thereof and/or the consistency within a food slab or between two food slabs is often irregular. So as to achieve consistently good quality during the slicing process, corrections therefore have to be made with changing product conditions.

### SUMMARY

The object of the present invention was therefore to provide a method, with which food slabs of different size and/or different consistency can be sliced.

The object is achieved by a method for slicing a food slab into food slices and/or for portioning food slices by means of a slicing device, which has a cutting blade with which the food slices are separated from the food slab, wherein an oscillation sensor is provided, which receives oscillations that are produced when the cutting blade contacts the food slab, when the cutting blade enters the food slab and/or when the food slab is cut, and wherein the signal of the oscillation sensor is used to set the slicing process and/or the portioning process.

The present invention relates to a method for slicing a food slab into food slices. Food slabs of this type, for example sausage, cheese or ham, are typically between 300 and 3,500 millimetres long. These food slabs are then placed into the slicing device and are transported continuously or intermittently by means of a transport means in the direction of a rotating cutting blade. The cutting blade may be a circular blade or a sickle blade for example. This cutting blade separates food slices from the front end of the food slab. The slices thus separated generally fall onto a portioning device, with which they are combined to form portions and are then transported away.

In accordance with the invention, an oscillation sensor is provided, which receives oscillations, in particular sound waves, that are produced when the cutting blade contacts the food slab, when the cutting blade enters the food slab and/or when the food slab is cut. On the basis of the measurement, the oscillation sensor generates a signal that is used for the setting of the cutting process, preferably for the automatic setting of the cutting process. The oscillation sensor is preferably a sound sensor, which measures airborne sound and/or structure-borne sound. The sensor is preferably arranged on or in the vicinity of the slicing device, such that it is not soiled by particles that are flung around. The signal of the sensor is forwarded to a process control, which, based on the signal, sets the slicing process and/or the portioning process. The measured oscillation may be processed already in the sensor or in a process control by filtering out and/or amplifying specific frequencies for example. Furthermore, the measured signal may be processed mathematically. Discrete oscillation values and/or oscillation profiles may be evaluated. The signal of the sound sensor is preferably detected as a function of the position, in particular the angular position, of the cutting blade. The device thus knows which oscillation or which oscillation profile occurs at a specific angular position of the cutting blade. For example, it is thus possible to establish the size of the circumference of the food slab and/or, if a number of food slabs are sliced simultaneously, which food slab is currently being sliced and/or the number of food slabs from which the cutting blade separates food slices during one revolution.

The present invention is based on the finding that the oscillations and/or the oscillation profile produced when the cutting blade contacts the food slab, when the cutting blade enters the food slab and/or when the food slab is cut depend(s) on the consistency of the food slab to be sliced and/or on the position at which the cutting blade contacts the product. For example, an evaluation device, which is connected to the oscillation sensor and which evaluates the oscillations, in particular sound waves, produced by the oscillation sensor when the cutting blade contacts the food slab, when the cutting blade enters the food slab and/or when the food slab is cut, identifies the consistency of the food slab being sliced, that is to say it evaluates whether the food slab is relatively soft or relatively hard, for example highly chilled or frozen. On the basis of this analysis, at least one process parameter of the slicing process critical for the respective cutting process is set at the slicing device, preferably automatically. The consistency of the food slab also depends, inter alia, on the composition thereof. For example, muscular meat has a different consistency compared to fatty tissue. Since the distribution between fatty tissue and muscular tissue may vary locally in a food slab and may change from one food slab to another food slab, even if the product is the same, the slicing process and/or the portioning process must be adapted accordingly so as to achieve an optimal result. Further parameters that influence the consistency of the food slab for example include the salt content of the food slab for example. In particular, the salt content may differ locally in the food slab, for example because fat absorbs less salt than muscular tissue.

A critical process parameter of the slicing process, which is set at the slicing device on the basis of the signal of the oscillation sensor, is the speed of rotation and/or the orbital speed of the cutting blade for example. Alternatively or in addition, the X-Y position of the cutting blade relative to the food slab can be set. Furthermore, the number of empty cuts, which are required for the portioning process, is preferably adapted, preferably automatically, in accordance with the signal and/or in accordance with a changed speed of rotation. The speed and/or acceleration to which the finished portions are subjected as they are transported away is preferably also changed in accordance with the signal of the oscillation sensor.

If the measured oscillation reveals, for example, that the product is a relatively soft product, the speed of rotation of the cutting blade is preferably reduced, for example so as to prevent the separated slices from being catapulted away to the side due to the friction of this relatively “wet” slice at the cutting blade. In this case, the speed of rotation of the cutting blade and/or the speed of an orbital movement, which is optionally provided, of the cutting blade can be reduced. The number of empty cuts made for the portioning of the food slit then preferably also reduced.

If, by contrast, the product is of a relatively hard consistency, the slicing process may take place at a relatively high cutting speed. In this case, the speed of rotation of the cutting blade and/or the speed of an orbital movement, which is optionally provided, of the cutting blade may be set relatively high. The number of empty cuts made is then preferably increased however so that more time is available to transport away the respective, finished portion, because the adhesion of the food slices to one another and/or to the conveying belt in the case of products having a relatively hard consistency is reduced. The respective portion is thus prevented from being “endangered”, that is to say from slipping relative to the transport belt and/or from being changed undesirably in terms of the arrangement of the food slices relative to one another.

Alternatively or in addition, the position of the cutting blade relative to the food slab can be changed so as to change the point of entry of the cutting blade and/or the ratio between pushing and pulling of the cutting blade during the slicing process. A change of this type is made by an “XY-adjustment” of the cutting blade and/or of the cutting blade head. This adjustment to the position of the cutting blade relative to the food slab is preferably carried out when the cross section of the food slab changes and/or in accordance with the consistency of the food slab.

The oscillations that occur when the cutting blade contacts the food slab, when the cutting blade enters the food slab and/or during the cutting process, and on the basis of which the consistency of the food slab is determined, can also be used for the setting of other parameters relevant to the slicing process. For example, in the case of a product having a “soft” consistency, a means can be activated, preferably automatically, so as to prevent the slip/stick effect at the cutting edge or the cutting screen. For example, the cutting edge/cutting screen can be oscillated and/or an electrical charge can be applied to the cutting edge, said charge then repelling the food slab from the cutting edge/cutting screen and thus reducing the static friction between the food slab and the cutting edge/cutting screen.

Alternatively or in addition, the manner in which a gripper is engaged with the rear end of the food slab can be made dependent on the oscillations that are measured when the cutting blade contacts the food slab, when the cutting blade enters the food slab and/or during the cutting process. With a food slab having a relatively hard consistency, for example salami, or a product having a low fat content, a shallower penetration depth of the gripper into the product is required compared to a relatively soft product, such as aspic, a product having a high fat content, or the like.

The cut-off food slices are generally portioned downstream of the cutting blade. A portioning process of this type is known to a person skilled in the art and generally consists of a plurality of transport means, for example a delivery table and/or at least one conveying belt, which are preferably arranged in succession. At least one conveying belt or the delivery table is preferably height-adjustable. By means of this portioning process, the cut-off food slices are divided into portions, for example having x food slices and/or in a weight-accurate manner, and are then transported away in portions. In accordance with the invention, in the case of this aspect of the present invention, the portioning process is set, preferably automatically, by the signal of the oscillation sensor, which measures the oscillations that occur when the cutting blade contacts the food slab, when the cutting blade enters the food slab and/or during the cutting process.

For example, food slices having a relatively hard consistency, that is to say for example chilled or frozen food slices, demonstrate reduced adhesion/friction to one another and/or to the means on which they are placed compared to food slices having a relatively soft consistency. This means that the accelerations that can be implemented during the portioning process, for example to transport away the finished portion, have to be slowed with food slices having a relatively hard consistency so as to prevent the food slices from slipping, that is to say from being endangered, relative to one another and/or relative to the conveying belt. In addition, the cut food slices, which fall onto the portioning system, have different trajectories due to their consistency. The acceleration and/or speed at which a finished portion is transported away is/are consequently preferably set on the basis of the signal of the oscillation sensor.

The position of the transport means onto which the respective food slices fall is set in accordance with the signal of the oscillation sensor, either in accordance with the invention or preferably. This adjustment may be an adjustment in a plane and/or a height adjustment.

Alternatively or in addition, the number of empty cuts, that say the number of cutting motions that the cutting blade carries out without separating a food slice from the food slab, is set in accordance with the measured oscillations that occur when the cutting blade enters the food slab and/or during the cutting process, that is to say for example in accordance with the consistency of the product, in particular so that sufficient time, but not too much time is available to carry out the portioning process reliably.

In accordance with a preferred aspect of the present invention, a food slab is placed in the slicing device and is transported in the direction of the cutting blade, and the oscillation sensor receives the oscillations that are generated when the cutting blade first contacts the food slab. The slicing device thus knows the position of the food slab on the transport means in the slicing device. For example, the product can be cut to a minimal extent in a controlled manner by means of this precise knowledge of the position of the food slab. For example, once the signal has been received, one or more slices may be cut as “waste” before the cutting of the “good portions” begins. Alternatively or in addition, the signal of the product sensor can be used to determine whether or not the respective cut slice is a slice of sufficient quality, that is to say a slice having a sufficient cross section.

If a plurality of food slabs are cut simultaneously in parallel, the signal of the oscillation sensor that is generated when the cutting blade first contacts the respective food slab can also be used to determine when the cutting blade was first contacted with all food slabs to be sliced in parallel. For example, one or more food slices per food slab are then cut off and discarded from this moment, before “good portions” are cut off from all food slabs to be in parallel. This preferred embodiment has the advantage that only one oscillation sensor required for all food slabs sliced in parallel. An optical sensor, which is susceptible to soiling, does not have to be used as a sensor. The number of slices that cannot be used for “good portions” is minimized. A sound profile is preferably analysed in this preferred embodiment.

In accordance with a further or preferred aspect of the present invention, an oscillation sensor is provided, which receives oscillations that are produced when the cutting blade contacts a foreign body, which is preferably located within the food slab, and the signal of said sensor is used to control the slicing device and/or portioning process.

Foreign bodies of this type may be bone or metal inclusions for example. As soon as the oscillation sensor identifies that the cutting blade has made contact with a foreign body of this type, the slicing device and/or the portioning process is/are controlled accordingly, preferably stopped very quickly, and/or the cutting blade is very quickly brought out of contact with the food slab by means of an axial stroke movement. The advance of the food slab is also preferably stopped in this case. Alternatively or in addition, the portioning process may be set such that the cut-off food slice containing the foreign body is discarded.

For example, the foreign body may also be a gripper, with which the rear end of the food slab is grasped. As soon as the oscillation sensor identifies that the cutting blade is in the direct vicinity of the gripper and/or has already contacted said gripper, the cutting blade is brought out of engagement with the food slab, in particular by retracting the gripper from the cutting plane and/or by moving the cutting blade out of the cutting plane.

In accordance with a further or a preferred aspect of the present invention, the distance between the front end of the food slab and the cutting blade, said distance being provided in the case of “empty cuts” required for the portioning of the cut food slices, is set by means of the oscillations that are produced when the cutting blade contacts the food slab, when the cutting blade enters the food slab and/or during the cutting process. For example, with a food slab having a consistency that is hard, either on the whole or locally, a smaller distance can be set compared to a relatively soft product, which oscillates and/or flows relatively heavily. Due to this embodiment of the present invention, which may be provided in accordance with the invention or in a preferred manner, the distance between the front end of the food slab and the cutting blade can be minimized. The distance between the front end of the food slab and the cutting blade can be achieved by changing the position of the cutting bide relative to the front end of the food slab and/or by retracting the food slab.

In accordance with an aspect of the present invention, which may be a further aspect or an aspect provided in accordance with the invention, an oscillation sensor is provided, which receives oscillations that are created when the cutting blade contacts the food slab, when the cutting blade enters, the food slab and/or when a food slab is cut and, on the basis of the oscillations, identifies if the product is placed incorrectly, that is to say is placed at an incline relative to the cutting plane for example, which may be the case for example if the gripper and/or the conveying belts no longer hold the food slab sufficiently. In such a case, the cutting process is preferably interrupted immediately so that a member of staff can remove the corresponding food slab from the slicing device and/or can re-engage the gripper with the food slab.

A plurality of food slabs is preferably sliced simultaneously. The signal received by the sensor is preferably evaluated such that an evaluation device knows which food slab(s) is/are currently in contact with the cutting blade and/or how many food slabs are sliced simultaneously during one revolution of the cutting blade and/or during one complete orbital movement. For example, it is preferably possible on the basis of the measured oscillations or the measured oscillation profile to establish the track of the slicing, device in which a food slab is currently being sliced at a specific moment.

Merely a single oscillation sensor is preferably required for a multiplicity of food slabs, which are sliced simultaneously. One oscillation sensor per slicing device is therefore generally sufficient.

The respective fond slabs, which are sliced simultaneously, may be identical or different products. Furthermore, the feed rate at which the respective food slab is sliced can be set individually per food slab.

The present invention further relates to a method for slicing a food slab into food slices by means of a slicing device, which has a cutting blade with which the food slices are separated from the food slab, wherein an oscillation sensor is provided, which receives oscillations that are produced when, the cutting blade contacts the food slab, when the cutting blade enters the food slab and/or when the food slab is cut, and identifies incorrect functioning of the cutting blade on the basis of the oscillations.

For example, this aspect of the present invention makes it possible to determine if the cutting blade detaches from the slicing device and/or if part of the cutting blade has broken off. For example, an imbalance is thus produced, as a result of which oscillations are produced, which are measured by the oscillation sensor and which signal to a corresponding evaluation device that the cutting blade is functioning incorrectly. In particular when the cutting blade enters the food slab, corresponding oscillations are created that signal to an evaluation device that the cutting blade has detached from the slicing device and/or that the cutting blade is functioning incorrectly in another way.

In all methods, which are provided in accordance with the invention or in a preferred manner, a sound profile is preferably evaluated. For example, the oscillation profile that is created whilst the cutting blade is engaged with one or more food slabs, simultaneously and/or in succession, is evaluated. Alternatively or in addition, the oscillation profile is analysed over a fixed period of time, in a specific position of the cutting blade and/or over a specific path of the cutting blade. Alternatively or in addition, only specific frequencies and/or frequency bands are analysed. The sound profile may be processed before it is evaluated. For example, one or more frequencies, for example background noise, are filtered and/or the signal profile can be processed mathematically.

Alternatively or in addition, the oscillation, for example the sound, is measured and/or analysed in accordance with one or more specific positions, for example angular positions and/or angular sections, during a complete revolution and/or orbital movement of the cutting blade. For example, the oscillation sensor is only activated in these angular positions and/or during these angular sections, the signal is only analysed in these angular positions and/or during these angular sections and/or the measured signal is correlated with the angular position of the cutting blade. For example, it may be predefined to the slicing device and/or the slicing device may learn at which angular position (0-360°) the cutting blade contacts the respective food slab, enters said food slab and/or exits again from said food slab. It is then expected that the sensor detects a corresponding oscillation at this angular position and/or in these angular sections, said oscillation being created when the cutting blade contacts the respective food slab and/or during the cutting process. If this oscillation is absent, the device knows that the cutting blade is not yet engaged with the respective food slab, that is to say that said food slab has not yet been transported into the cutting plane. The specific food slab(s) and/or the number of food slabs with which the cutting blade is engaged during a complete revolution or orbital movement can thus be determined. The device preferably also knows the angular position at which the cutting blade exits again from the respective food slab.

Furthermore, one or more reference signals are preferably stored in the evaluation device. The respective measured signal or signal profile is compared with the respective reference signal and the slicing device and/or the portioning device is/are controlled/regulated in accordance with this comparison. During this process., a deviation, but also a coincidence, between the measured sound profile and the reference profile may result in the fact that the evaluation unit identifies a need for regulation and/or control and transmits a corresponding signal to the slicing device. The slicing device is preferably self-learning.

Alternatively Of in addition, the current consumption of the rotatable cutting blade drive and/or the contouring error of the rotatable cutting blade is/are measured. Both measurements make it possible to draw conclusions concerning the food slab/cutting blade system, both individually and in combination, that is to say, for example, the moment at which the cutting blade contacts the respective food slab and at which the cutting blade cuts the respective food slab and/or the consistency of said food slab can be established, if the consistency of the food slab changes locally or between two food slabs and/or the cutting blade becomes blunt, the current consumption and/or the magnitude of the contouring error changes. This change is evaluated and the slicing device and/or the portioning process is/are controlled and/or regulated, as described above. The current consumption and/or contouring error may also be used to determine whether the cutting blade is engaged with one or more food slabs. The current consumption and/or the contouring error can be measured alternatively or additionally to the oscillation measurement. The entire disclosure provided in conjunction with the oscillation measurement applies analogously to the measurement of the current consumption and/or the contouring error. Reference values for the current consumption and/or the contouring error are preferably stored, on the basis of which an evaluation device can draw conclusions, for example, concerning the consistency and/or the sharpness of the cutting blade.

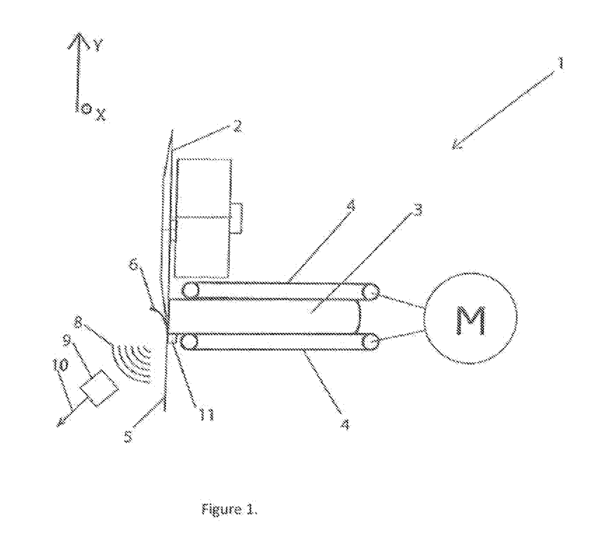

The invention will be explained hereinafter on the basis of FIGS. 1-6b and Examples 1 to 6. These explanations are merely exemplary and do not limit the general inventive concept. The explanations apply equally to all aspects of the present invention. The present application claims priority to German patent application No. DE 102011119719.6 filed on Nov. 30, 2011, incorporated by reference herein for all purposes.

### DETAILED DESCRIPTION OF THE DRAWINGS

FIG. 1 shows a first view of a slicing device shows a second view of a slicing device.

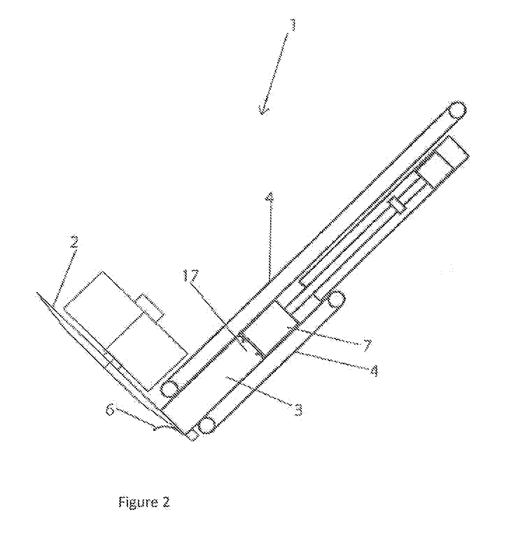

FIG. 2 shows a second view of a slicing device.

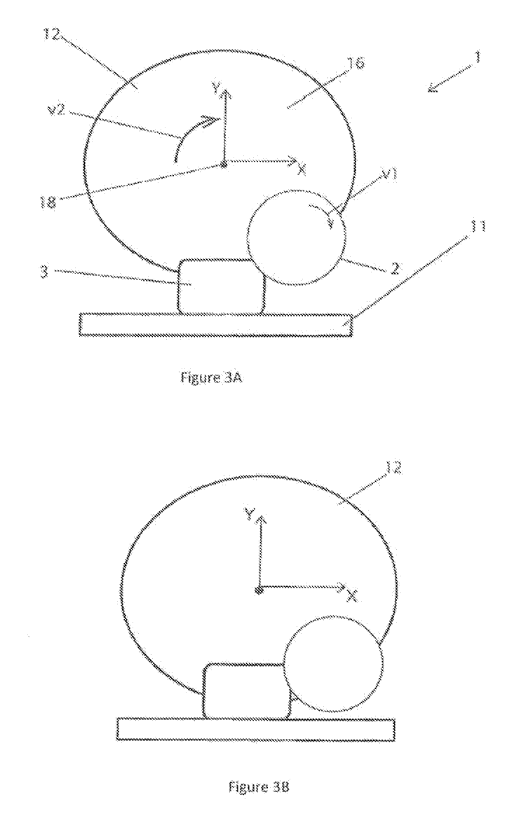

FIGS. 3A and 3B show a X-Y-adjustment of the cutting lead to change the cut of the food slab.

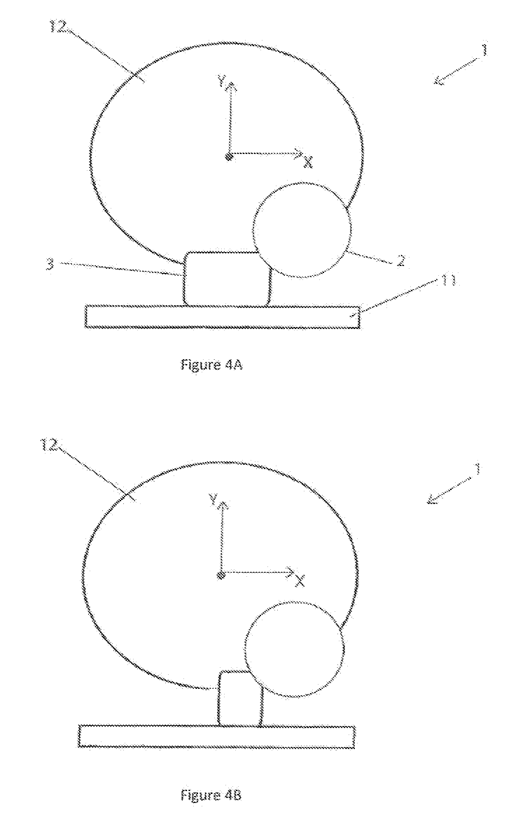

FIGS. 4A and 4B show the position of the cutting head with food slabs of different cross section.

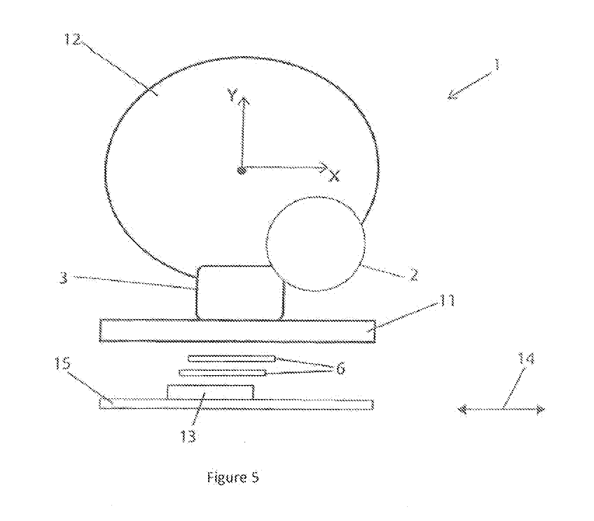

FIG. 5 shows a slicing device with slicing system.

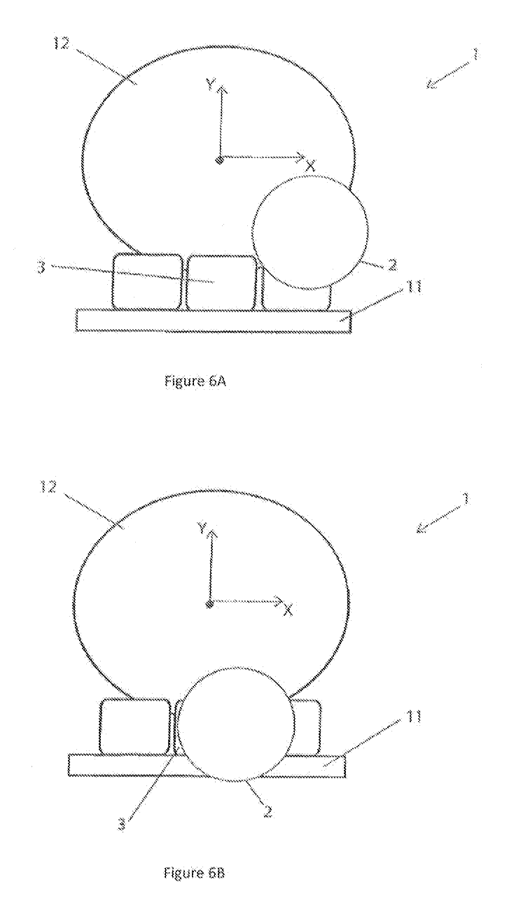

FIGS. 6A and 6B show the cutting of a plurality of food slabs simultaneously.

### DETAILED DESCRIPTION

FIGS. 1 and 2 show a slicing device with which the method(s) according to the invention can be carried out. The slicing device 1 has a cutting blade 2, which cuts a food slab 3 into food slices 6. The cutting blade 2 rotates about a cutting blade head 16. The sliced food slices 12 are generally configured into portions on a delivery table not illustrated, see FIG. 5), transported away and then packed. A person skilled in the art will recognize that a plurality of food slabs can be sliced simultaneously. The food slab 3 is transported in this case by means of two conveying belts 4, either continuously or discontinuously, along the product route in the direction of the cutting plane 5, which is defined by the cutting blade 2 and the cutting strip 11. The cutting blade 2 and the cutting strip 11 cooperate during the cutting process. A cutting gap must always be present between the cutting blade 2 and the cutting strip 11 so as to prevent the cutting blade from contacting the cutting strip. This cutting gap should be as small as possible however so as to prevent a “tearing” of the respective slice and/or “burr formation”. The thickness of the slice is determined from the distance over which the food slab is advanced between two cuts. With a constant speed of rotation of the cutting blade, the thickness of the slice is controlled is the feed rate of the food slab. The conveying belts 4 are open on the inlet side. In particular to form portions, empty cuts have to be made with high-performance slicers, during which the cutting blade continues its cutting motion without engaging the product. This is preferably achieved by moving the cutting blade 2 out of the cutting plane 5 and away from the front end of the food slab 3. Alternatively or in addition, the food slab can be retracted from the cutting plane. As soon as a sufficient number of empty cuts have been made, the cutting blade and/or the food slab is/are moved back in the direction of the cutting strip 1. As can be seen in particular from FIG. 2, the food slab is brought into contact at its rear end 17 with a gripper 7. This contact is preferably produced once the slicing of the respective food slab has already begun. In particular, the gripper ensures that the food slab maintains its position when it has already been sliced to a large extent and the contact area with the transport means 4 is reduced. In addition, the remaining piece of the food slab is disposed of with the gripper.

The device 1 has at, least one n sensor 9 illustrated in FIG. 2. This oscillation sensor 9 receives oscillations 8, in particular sound waves, which are generated when the cutting blade contacts the food slab, when the cutting blade enters the food slab and/or during the cutting process, and supplies a signal 10 to an evaluation unit. A person skilled in the art will recognize that the evaluation unit can be part of the sensor. On the basis of this signal 10, the evaluation unit, for example the system control of the slicing device, identifies for example whether the food slab currently located in the slicing device has a relatively hard or soft consistency. The slicing device or the slicing process is set, tin particular automatically, on the basis of this analysis. In particular, the speed of rotation and/or the orbital speed of the cutting blade, the number of empty cuts and/or the positioning device is/are set on the basis of the signal of the oscillation sensor.

The oscillation sensor 9 is a arranged either directly on the slicing device and thus receives the oscillations thereof directly and/or is arranged in the vicinity of the slicing device and receives airborne oscillations. The oscillation sensor is preferably a sound sensor, in particular with frequency-selective monitoring of structure-borne and or airborne sound. One oscillation sensor per slicing device is generally sufficient, even if a plurality of food slabs is to be sliced simultaneously. The oscillation sensor is preferably arranged such that it is not damaged and/or is not soiled by particles of food that are flung around and/or such that cleaning of the slicing device is not restricted.

The oscillation sensor measures the frequency and the amplitude of the oscillations occurring and/or of an oscillation profile.

The cutting blade head 16 of the slicing device is illustrated in FIGS. 3a and 3b. In the present ease, a circular blade 2 is arranged on the cutting blade head and rotates about its own central axis at a speed v1. To ensure that the circular blade releases the food slab periodically and that said food slab can then be transported further in its longitudinal direction, the circular blade rotates over an orbital path 12 about the axis of rotation of the cutting blade head at a speed v2. This movement is the “orbital movement” at an “orbital speed”. If the evaluation unit then determines on the basis of the sound waves produced upon contact between the cutting blade and the food slab, entry of the cutting blade into the food slab and/or during the cutting process that the product is a relatively soft product, the speed v1 and/or v2 is/are preferably reduced. The number of empty cuts to be carried out for the portioning process is preferably adapted in particular in accordance with the speed v2, that is to say, with an increase of v2 the number of empty cuts is also increased, and vice verse. Alternatively or additionally, the position of the axis of rotation 18 in the X direction and/or in the Y direction, which are arranged perpendicular to one another and perpendicular to the direction of transport of the food slab, can be changed on the basis of the measured oscillations. For example, the location at which the cutting blade contacts the circumference of the food slab 3 can be set by changing the axis of rotation of the blade head. Compared to FIG. 3a, the axis of rotation of the cutting head in the embodiment according to FIG. 3b has been lowered in the Y direction and shifted to the right in the X direction.

In the example according to FIGS. 4a and 4b, the fact that an X-adjustment and/or Y-adjustment of the cutting blade 2 can also be made if the cross section of the food slab 3 is changed is illustrated. This change may occur from one food slab, to another food slab or within a single food slab. The change to the cross section of the food slab may be determined by the evaluation device, for example as a result of the position, in particular angular position, of the cutting blade, at which the oscillations occur when the cutting blade contacts/enters the food slab. If a change is determined, the axis of rotation of the cutting blade head is adjusted, for example, in the X direction and/or direction so as to leave the location of contact between the cutting blade and the food slab substantially constant.

FIG. 5 illustrates the portioning of the cut-off food slices. Once the food slices 6 have been cut off, they fail along a trajectory onto the delivery table 15, where they are configured into a portion. The trajectory depends, inter alia, on the speed of rotation of the cutting blade 2, but also on the consistency of the food slab. A food slice having a soft consistency, that is to say having a high fat content and/or a relatively high temperature, “sticks” to the cutting blade for longer and is thus catapulted more to the side from the cutting blade compared to a relatively hard product. This can be accommodated by reducing the speeds of rotation v1 and/or v2. Alternatively or in addition, the position of the delivery table is changed, as illustrated by the double headed arrow 14. This adjustment can also be made vertically, so as to change the falling height of the respective feed slice. Furthermore, the acceleration to which the finished portions are subjected is preferably adapted to the consistency of the food slab. The acceleration is preferably reduced with harder products, and vice versa. The number of empty cuts that have to be made for the portioning process is dependent on v1 and/or v2 and on the time that is required to transport away a finished portion. The number of empty cuts per portion is preferably ascertained once these parameters have been established and are adapted if these parameters change.

FIGS. 6a and 6b show the cutting and slicing of a plurality of food slabs simultaneously. In the present case, the slicing device has three tracks and up to three food slabs can be sliced in parallel. A person skilled in the art will recognize that just two, or more than three, food slabs can also be sliced in parallel however. If a new food slab is placed into the respective track, it is transported in the direction of the cutting blade until it engages therewith. The moment at which the respective food slab and the cutting blade contact for the first time is identified by the evaluation unit of the slicing device by a corresponding oscillation measurement. A specific number of food slices not corresponding to the stipulated quality requirements are then cut off and discarded before the slicing of the actual “good portions” begins. Merely one oscillation sensor is preferably necessary to detect the first contact between the respective food slab in the respective track and the cutting blade. The device preferably identifies which food slab(s) is are currently engaged with the cutting blade and/or the number of fund slabs that have been sliced during an orbit of the cutting blade about the axis of rotation of the cutting head.

### EXAMPLES

### Example 1

Product consistency: A typical problem when slicing smoked ham, bacon or sausages and cheese is that the product can only be cut optimally within a very narrow consistency range. It is desirable to cut the product whilst it is rather chilled so as to obtain good stability of the product during the cutting process, but, at the same time, the product should not be frozen, since the slices will not hold together in the portioning process following the cutting process and it will be impossible to produce a good portion, in addition to temperature, consistency is also determined for example by the salt content of the product and/or the fat/meat content, which changes within the food slab and/or from one food slab to another food slab. The salt content of the food slab depends, letter alia, on the fat/muscle proportion thereof, since fat absorbs less salt than muscular meat.

For example, it may be that the product is for “soft”. Then, the speed of rotation of the Cutting blade generally has to be reduced so as to prevent the slices from being catapulted away to the side as a result of the friction of the “wet” slices at the cutting blade. If, by contrast, the product is frozen, the setting of the portioning process has to be adapted. The slices have no, or reduced, adhesion to one another and/or to the delivery table, and for example the acceleration of a finished portion, which has to be implemented for example to transport this portion away, therefore has to be slowed. At the seine time., empty cuts, that is to say revolutions of the cutting blade without separation of food slices, have to be added so as to have more time for the portioning process, which is now stowed.

The oscillation sensor, for example a sound sensor, then monitors the sound profile of the system formed of the cutting blade and product. A clear distinction can be made between the noise or the sound profile when cutting a soft product or a hard, frozen product. On the basis of this knowledge (analysis of the sound profile), the control/regulation of the slicing device can then automatically adjust critical process parameters. If the evaluation unit of the sound sensor identifies a profile indicating a soft product, the machine reduces the speed of rotation of the cutting blade, for example automatically. If the sound sensor identifies a profile indicating a hard/frozen profile, the machine automatically reduces the acceleration Parameters and possibly also the speed parameters of the portioning process and increases the number of empty cuts accordingly.

The parameters can be regulated or adapted in various ways. For example, a reference oscillation profile (sound profile) can be stored in the evaluation unit and can be assigned specific process parameters. With a defined deviation of the current sound profile from the reference sound profile, the relevant cutting and/or portioning parameters are adapted In steps. In another variant, a plurality of reference sound profiles can be stored. For each reference sound profile (for example “soft” sound profile, “good” sound profile, “hard” sound profile), a machine/parameter setting optimized to this product consistency (reference sound profile) is stored and is then set if the evaluation unit, has determined a corresponding consistency of the food slab.

### Example 2

In accordance with a further embodiment o method according to the invention, the oscillation sensor, for example the sound sensor, or the measured sound profile is used to control the cutting of food slabs in a slicing machine. All food slabs sliced using modern slicing machines (slicers, high-performance slicers) have a finite length. Typical food slab lengths are between 300 mm to 3,500 mm. If a food slab is cut to its end, a new food slab has to be placed into the respective track and supplied to the cutting plane. A number of food slabs may possibly have to be placed substantially simultaneously into the respective track of the slicing device. When transporting the respective food slice in the direction of the cutting plane, it is necessary to know the position of the front edge of the respective food slab so as to implement a controlled, minimal cut of the product and to decide from which position of the food slab a slice or portion of sufficient quality can be sliced. At this moment, the slicing machine then switches from “cutting mode” into the “slicing mode”.

The front edge of the food slab is nowadays often detected via optical sensors, which establish the position at a specific distance from the cutting plane. However, these sensors have the disadvantage that they are installed in an area that is constantly soiled by product particles, which leads to incorrect functioning of the optical sensors. Furthermore, when a plurality of food slabs to be cut simultaneously is supplied, these sensors generally only monitor the front edge of the first (longest) food slab. To be sure that all food slabs sliced simultaneously are cut cleanly and to anticipate a slice/portion of good quality over each track, more than the maximum theoretical length deviation of the products always has to be cut off in order to reliably obtain a good slice/portion over all tracks. This is irrespective of the actual size of this deviation in length between the food slabs currently sliced simultaneously and results in a loss of product which is not insignificant.

In accordance with the invention, the oscillation profile, for example the sound profile, of the system formed of the cutting blade/food slab is therefore used to identify when all food slabs are cut and/or are engaged with the cutting blade.

If, for example, two food slabs are sliced simultaneously, there are three different basic sound profiles; Profile 1—there is no food slab provided. Profile 2—one food slab is provided. Profile 3—two food slabs are provided. Once profile 3 is provided, either the portioning process can be started immediately, or a predefined number of slices can be cut off from the food slab(s) and then the portioning process can be started.

The advantage lies in the fact that no additional optical sensors have to be installed, that there is no risk of soiling and incorrect functioning of the optical sensors and/or that a theoretical position of the food slab in the cutting plane is not assumed, but instead the sound sensor establishes directly the moment from which the desired number of food slabs are engaged with the cutting blade.

### Example 3

A food slab falls from the gripper.

It may be, when supplying and/or replenishing food slabs, that one or more food slabs are not held securely by the supply systems (either traction belts and/or product grippers). In this case, this food slab travels/fails in an uncontrolled manner through the cutting shaft or through the cutting plane. Very thick slices or pieces of food slab are thus separated in a completely uncontrolled manner. A controlled cutting and portioning process is no longer possible. This state generates massive uncontrolled forces on the rotating cutting blade. Furthermore, these pieces often remain lying on the portioning table in an uncontrolled manner and impair the proper slicing and/or positioning of the subsequent food slabs too. It is necessary to stop the cutting device and to clear/clean the system. It is dependent on the attentiveness and/or presence of an operator as to whether and when the cutting machine is stopped so as to prevent damage to the cutting blade and/or the machine and/or to clean the portioning region.

As a result of the monitoring of the oscillation profile, for example of the sound profile, by an oscillation sensor, it is possible to identify immediately if a product falls through the cutting plane in an uncontrolled manner. The machine can then be stopped immediately. This prevents damage and prevents the entire food slab from being cut in an uncontrolled manner. Product is saved and excessive soiling of the positioning region is prevented.

### Example 4

Contact, cutting blade/gripper.

In a further embodiment of the present invention, the sound sensor monitors whether the cutting blade hits against a metal object during the slicing process. For example, it may be that, as a result of damage to a product gripper (for example bending of one of the claws that hold the product), a dew of said gripper protrudes further than intended from the product gripper and reaches into the cutting plane at the end of the cutting process of a bar and collides with the cutting blade. This collision process generates particularly concise sound profiles. Even just a first contact is identified. When such a contact is identified, the slicing process is interrupted immediately. In other words, the gripper is immediately retracted from the cutting plane and or the cutting blade is immediately moved away from the cutting plane if a corresponding drive is, provided to intermittently move the cutting blade out of the cutting plane, for example to generate empty cuts. The cutting blade and the machine are preferably stopped and a corresponding warning signal is particularly preferably generated.

### Example 5

Foreign in the product.

It may be that undesired foreign bodies are located in the food slab to be sliced. These may be pieces of bone, broken-off parts of injection needles from previous processes and/or, for example, pieces of metal that have accidentally found their way into the product during previous process steps.

In this case, an oscillation sensor, for example a sound sensor, can likewise detect the contact of this foreign body with the cutting blade and can stop the cutting process analogously to Example 4.

### Example 6

Cutting blade detaches.

A further, as yet unresolved, problem encountered in high-performance slicing machines is that the cutting blade can detach from the cutting blade receptacle. This may be caused by an incorrect or unsatisfactory fastening of a fastening means, for example poor tightening of the screws. Furthermore, a fastening means may fail during the slicing process. This is particularly critical in “circular blade machines”. In this case, the cutting blade is only secured by a single central screw. If this detaches, the cutting blade immediately flies through the machine in an uncontrolled manner. Since the cutting blade itself is located on an orbital path and has an inherent rotation of up to 5,000 rpm, the energy contained in the now detached cutting blade is immense. This leads to partial or complete destruction of the machine through to a risk for the operator. Since the slicing machines do not currently identify such a state, there is a risk that the cutting blade head still rotating at cutting speed will accelerate the detached cutting blade as a result of its own weight and shoot it through the protection device of the machine. This may result in serious injures to people.

With an oscillation sensor, for example the sound sensor, such en event can already be identified at a very early stage. Insufficiently tightened fastening means alone, for example a screw, result in loud noises due to the wobbling of the cutting blade, the hitting of the cutting blade against the cutting blade head, etc. before the screws ultimately detach and lead to the above-described catastrophe. If such a sound profile of the system is identified, the machine can be stopped immediately and consequential damage can be prevented.

All explanations according to the figures and/or the examples apply accordingly to a device or a method in which the current consumption and/or the contouring error of the rotating cutting blade is/are measured.

### LIST OF REFERENCE SIGNS

1 slicing device

2 cutting blade

3 food slab

4 transport means

5 cutting plane

6 food slice

7 gripper

8 sound waves

9 oscillation sensor, sound sensor

10 signal

11 cutting edge

12 orbital path of the circular blade, orbital movement, orbit

13 food slice stack, portion

14 setting of the portioning process

15 delivery table, portioning table, portioning region

16 cutting blade head

17 rear end of the food slab

18 axis of rotation of the cutting blade head, midpoint of the orbital path

1. A method comprising:
slicing a food slab into food slices and/or for portioning food slices by means of a slicing device, which has a cutting blade with which the food slices are separated from the food slab,
wherein an oscillation sensor is provided, which receives oscillations that are produced when the cutting blade contacts the food slab, when the cutting blade enters the food slab and/or when the food slab is cut, and the signal of the oscillation sensor is used to set the slicing process and/or the positioning process.

2. The method according to claim 1, wherein a speed of rotation of the cutting blade and/or an orbital speed of the cutting blade is set.

3. The method according to claim 1, wherein the position of the cutting blade in an X direction and/or a Y direction is set.

4. The method according to claim 2, wherein the position of the cutting blade in an direction and/or a Y direction is set.

5. The method according to claim 1, wherein the food slices are portioned downstream of the cutting blade, and in that the portioning process is set o the signal.

6. The method according to claim 4, wherein the food slices are portioned downstream of the cutting blade, and in that the portioning process is set by the signal.

7. The method according to claim 5, wherein empty cuts are made for the portioning process, and in that the number of empty cuts is adapted to a speed of rotation of the cutting blade and/or to a orbital speed of the cutting blade.

8. The method according to claim 1, wherein a food slab is placed into the cutting device and is transported in the direction of the cutting blade, and in that the oscillation sensor receives the oscillations that are produced upon initial contact between the cutting blade and the food slab.

9. The method according to claim 6, wherein a food slab is placed into the cutting device and is transported in the direction of the cutting blade, and in that the oscillation sensor receives the oscillations that are produced upon initial contact between the cutting blade and the food slab.

10. The method according to claim 1, wherein a plurality of food slabs are sliced in parallel, at least temporarily.

11. The method according to claim 10, wherein the sensor receives the oscillations that are generated when, during a revolution of the cutting blade a food slice is first separated from all food slabs sliced in parallel.

12. The method according to claim 1, wherein an oscillation sensor is provided, which receives oscillations that are produced when the cutting blade contacts a foreign body, which is preferably located within the food slab, and the signal of said sensor is used to control the slicing device.

13. The method according to claim 9, wherein an oscillation sensor is provided, which receives oscillations that are produced when the cutting blade contacts a foreign body, which is preferably located within the food slab, and the signal of said sensor is used to control the slicing device.

14. The method according to claim 1, wherein en oscillation sensor is provided, which receives oscillations that are produced when the cutting blade contacts the food slab, when the cutting blade enters the food slab and/or when the food slab is cut, and identifies incorrect placement of the food slab relative to the cutting blade on the basis of the oscillations.

15. The method according to claim 1, wherein an oscillation sensor is provided, which receives oscillations that are produced when the cutting blade contacts the food slab, when the cutting blade enters the food slab and/or when the food slab is cut, and identifies incorrect functioning of the cutting blade on the basis of the oscillations.

16. The method according to claim 1, wherein a sound profile is evaluated.

17. The method according to claim 1, wherein the measured signal is compared with a reference signal.

18. The method according to claim 1, wherein the sound profile is analysed in accordance with the position of the cutting blade.

19. The method according to claim 1, wherein when the cutting blade contacts the food slab, when the cutting blade enters the food slab and/or when the food slab is cut, the change in current consumption and/or the contouring error of the rotatable drive is measured and this measurement is used to set the slicing process and/or the portioning process.

20. A method comprising:
slicing a food slab into food slices and/or for portioning food slices by means of a slicing device, which has a cutting blade with which the food slices are separated from the food slab,
receiving oscillations, with an oscillation sensor, that are produced when the cutting blade contacts the food slab, when the cutting blade enters the food slab and/or when the food slab is cut;
setting the slicing process and/or the positioning process using the signal of the oscillation sensor;
setting a speed of rotation of the cutting blade and/or an orbital speed of the cutting blade;
setting the position of the cutting blade in an X direction and/or a Y direction;
portioning the food slices downstream of the cutting blade;
setting the portioning process by the signal;
making empty cuts during the portioning process, and in that the number of empty cuts is adapted to the speed of rotation of the cutting blade and/or to the orbital speed of the cutting blade;
placing a food slab into the cutting device and transporting in the direction of the cutting blade, and in that the oscillation sensor receives the oscillations that are produced upon initial contact between the cutting blade and the food slab;
at least temporarily slicing a plurality of food slabs in parallel;
receiving oscillations with the oscillation sensor that are produced when the cutting blade contacts a foreign body, located within the food slab, and the signal of said sensor is used to control the slicing device;
receiving oscillations with the oscillation sensor that are produced when the cutting blade contacts the food slab, when the cutting blade enters the food slab and/or when the food slab is cut, and identifies incorrect placement of the food slab relative to the cutting blade on the basis of the oscillations;
evaluating a sound profile;
comparing the measured signal with a reference signal; and
analyzing the sound profile in accordance with the position of the cutting blade;
wherein the sensor receives the oscillations that are generated when, during revolution of the cutting blade, a food slice is first separated from all food slabs sliced in parallel; and
wherein when the cutting blade contacts the food slab, when the cutting blade enters the food slab and/or when the food slab is cut, the change in current consumption and/or the contouring error of the rotatable drive is measured and this measurement is used to set the slicing process and/or the portioning process.
